(19) United States
(12) Patent Application Publication
(10) Pub. No.: US 2016/0201722 A1
(43) Pub. Date: Jul. 14, 2016

(54) RADIAL ELECTRODYNAMIC BEARING

(71) Applicant: UNIVERSITE CATHOLIQUE DE LOUVAIN, Louvain-la-nueve (BE)

(72) Inventors: Bruno Dehez, Liernu (BE); Virginie Kluyskens, Limal (BE); Corentin Dumont de Chassart, Gentinnes (BE); Maxence Van Beneden, Braine-l'Alleud (BE)

(73) Assignee: Universite Catholique de Louvain, Louvain-la-Neuve (BE)

(21) Appl. No.: 14/913,027

(22) PCT Filed: Aug. 13, 2014
(86) PCT No.: PCT/EP2014/067306

§ 371 Date: Feb. 19, 2016

(30) Foreign Application Priority Data
Aug. 20, 2013 (GB) 1314840.8

(51) Int. Cl. F16C 32/04

(52) U.S. Cl. CPC F16C 32/0468; F16C 32/0474

(57) ABSTRACT

The invention provides a radial bearing for supporting a shaft of a rotating device comprising an inductor having an inductor axis, generating a magnetic field radial to said inductor axis having p pole pairs, a winding having loops disposed around a winding axis, magnetically coupled to said radial magnetic field, and connected in a closed circuit in such a manner that the net flux variation intercepted by said winding when said inductor and said winding are in rotation with respect to each other is zero when said inductor axis and said winding axis coincide, and a gap between said inductor and said winding. According to the invention, said armature winding comprises p−1 or p+1 pole pairs when p is larger than or equal to 1 and said armature winding comprises one pole pair when p is equal to 0.

### FIELD OF THE INVENTION

The invention relates to a radial bearing for supporting magnetically a shaft of a rotating device, comprising an inductor generating a magnetic field having p pole pairs and an armature winding having loops disposed around an armature axis, magnetically coupled to said magnetic field, and connected in a closed circuit in such a manner that the net flux variation intercepted by said armature winding when said inductor and said winding are in rotation with respect to each other is zero when said inductor axis and said armature axis coincide.

### DESCRIPTION OF PRIOR ART

Electrodynamic bearings are based on forces issued from the interaction between a magnetic field and currents induced in conductors resulting from a variation of the magnetic field seen by these conductors. This variation results from a time variation of the magnetic field or by a space variation of the field and a motion of the conductor. Preferably, the currents will only be induced when the rotor is not in its equilibrium position: the fact that no current flows in the conductors when the rotor is in equilibrium implies that there are no losses in this situation. Electrodynamic bearings offer the possibility to design stable passive magnetic bearings at room-temperature. However, the forces they develop depend on the rotor spin speed, which means that there are no forces when the rotor does not spin. Various electrodynamic bearings designs have previously been studied.

A magnetic bearing is known from U.S. Pat. No. 5,302,874, using conductive loops which interact with magnets to levitate a rotor and to centre it on a rotational axis. This document describes the principle of passive magnetic bearings: a plurality of permanent magnets produce a magnetic field and a plurality of loops move in relation to this magnetic field. The design is such that, when the loops move along a prescribed circular path, no electrical current flows in the loops. When the loops deviate from their prescribed path, a current is flowing in the loops tending to move the loop toward the prescribed circular path. In this bearing, means are provided for moving the loops in an axial direction and in a radial direction. As shown of FIGS. 6 and 7 of document U.S. Pat. No. 5,302,874, for the radial bearing, the radial conductive loops 22 on the loop-carrying disk 18 correspond in number and angular distribution to the poles of the magnets 38, 40 on the stator.

Document WO03021121 discloses a passive magnetic bearing for a generator/motor. In this radial bearing, the rotor comprises a Halbach array comprising a number of pole pairs, this number being 6 in the embodiment of FIG. 1. The stator comprises a lap winding having axial sections spaced apart one-half of the wavelength of on the lines of induction emanating from the rotor. As shown on FIGS. 1 and 2, the poles of the rotor and the poles of the stator winding have same angular periodicity.

### SUMMARY OF THE INVENTION

It is an object of the present invention to provide a radial bearing providing an improved stiffness.

The invention is defined by the independent claims. The dependent claims define advantageous embodiments.

According to a first aspect of the invention there is provided a radial bearing for supporting a shaft of a rotating device comprising:
a) an inductor having an inductor axis, generating a magnetic field having p pole pairs;
b) an armature winding having loops disposed around an armature axis, magnetically coupled to said magnetic field, and connected in a closed circuit in such a manner that the net flux variation intercepted by said armature winding when said inductor and said armature winding are in rotation with respect to each other is zero when said inductor axis and said armature axis coincide and
c) a gap between said inductor and said armature winding.
   According to the invention, said armature winding comprises p+1 or p−1 pole pairs when p is larger than or equal to 1 and said armature winding comprises one pole pair when p is equal to 0. The inductor may comprise permanent magnets and/or windings carrying a DC current. A plurality of said armature winding may be repeated between two successive poles, so as to form a winding having an increased recentring force.

Preferably, said armature winding comprises p+1 or p−1 loops distributed uniformly around the armature axis.

In a first embodiment of the invention, said magnetic field is radial to said inductor axis.

When said inductor is internal to said armature winding, said armature winding then preferably comprises p+1 pole pairs.

When said inductor is external to said armature winding, said armature winding then preferably comprises p−1 pole pairs.

In a second embodiment of the invention, said magnetic field is axial in relation to said inductor axis.

The inductor of the invention may be a rotor adapted for rotating around an axis. The armature winding is then a stator.

Alternatively, the said armature winding of the invention may be a rotor adapted for rotating around an axis. The inductor is then a stator.

The armature winding of the invention may be a lap winding.

The armature winding of the invention may also be a wave winding.

The inductor may comprise a Halbach array.

### SHORT DESCRIPTION OF THE DRAWINGS

These and further aspects of the invention will be explained in greater detail by way of example and with reference to the accompanying drawings in which:

FIG. 1 is a schematic section along a plane perpendicular to the axis of a radial bearing according to the invention where the magnetic field generated by the inductor is radial;

FIG. 2 is a schematic section along a plane perpendicular to the axis of a radial bearing according to the invention where the magnetic field generated by the inductor is axial;

FIG. 3 is a representation of the coordinate systems used for describing the motion of the rotor with respect to the stator of a radial bearing according to the invention;

FIG. 4 represents components of the magnetic vector potential created by a seven pole pairs decentred inductor, expressed in a frame attached to the armature winding;

FIG. 5 to 9 are partial schematic views of the layout of possible windings for a bearing according to the inventions, in a flat configuration.

The drawings of the figures are neither drawn to scale nor proportioned. Generally, identical components are denoted by the same reference numerals in the figures.

### DETAILED DESCRIPTION OF EMBODIMENTS OF THE INVENTION

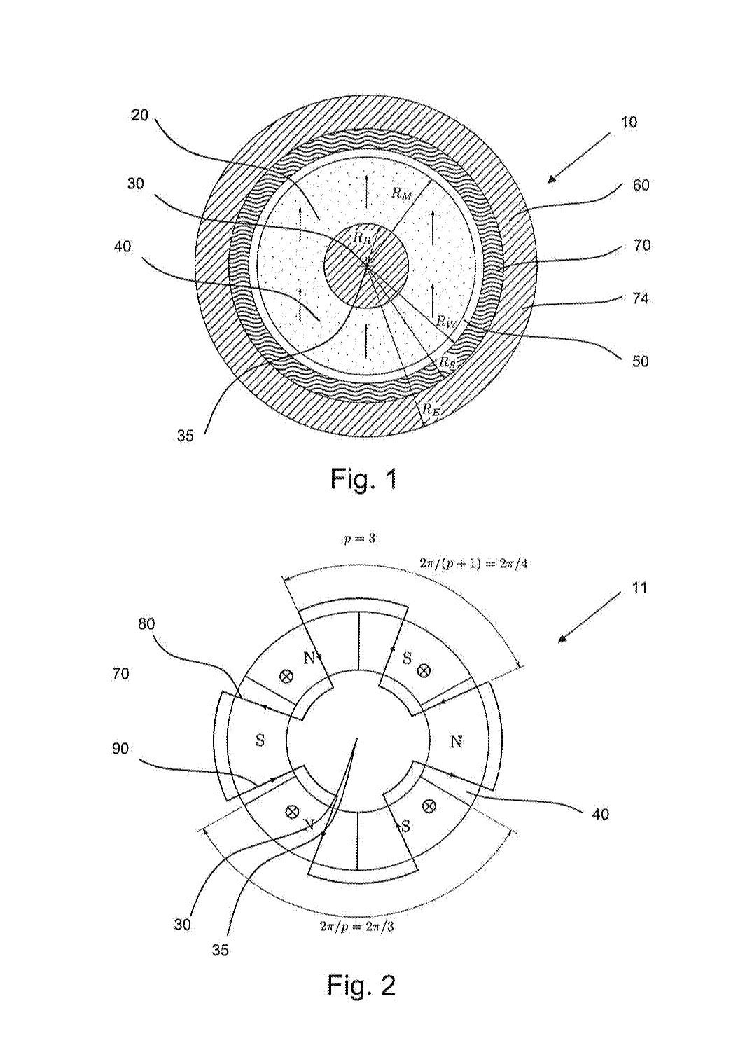

FIG. 1 is a schematic section along a plane perpendicular to the axis of an example of a radial bearing 10 according to a first embodiment of the invention. Its rotor 20 comprises a rotor mechanical axis 30 and an inductor 40 which may be a permanent magnet arranged around the axis 30. In the example shown, the magnet is a parallel magnetized annular permanent magnet, having thus one pole pair. In the present description the number of pole pairs of an inductor is designated by “p” and may take the values (0, 1, 2, 3, 4 . . . ). The permanent magnet inner radius is noted R_{R} and its outer radius R_{M}. The stator 60 comprises an armature winding 70, whose inner radius in noted R_{w} and outer radius is noted R_{S}. A ferromagnetic yoke 74 closes the magnetic circuit from inner radius Rₛ to outer radius Rₑ. An air gap 50 separates the rotor 20 from the stator 60. The winding is connected in such a way that when the rotor is centred, no currents are induced in it: they are null flux windings. In FIG. 1, the inductor 40 is internal to the winding 70. However, as will be understood from the principles explained hereunder, the invention also applies where the inductor is external to the winding. In FIG. 1, the inductor 40 is rotating, while the winding 70 is static. The invention also applies where the inductor is static and the winding is rotating. The ferromagnetic yoke 74 may be absent. The winding may also be inserted between ferromagnetic teeth. The inductor 40 may be comprised of a Halbach array, or of other arrangement of permanent magnets and/or windings carrying a DC current.

FIG. 2 is a schematic section along a plane perpendicular to the axis of a radial bearing 11 according to a second embodiment of the invention where the magnetic field generated by the inductor is axial. In the example shown, the inductor 40 comprises three magnets having a north pole (magnetization oriented upwards in the drawing) and three magnets having a south pole (magnetization oriented downwards in the drawing). The number of pole pairs p of the inductor 40 is equal to 3. The inductor pole pairs are separated at an angle of 2π/p=2π/3. The armature winding 70 is a wave winding and comprises 4 forth conductors 80 and 4 back conductors 90 connected in a closed circuit and forming 4 loops separated at an angle of 2π/(p+1)=2π/4. These loops form 4 pole pairs, the circled crosses representing each a pole of these pole pairs. The magnets of the inductor 40 may be static and form a stator while the armature winding 70 may be mounted on a rotating disk and form a rotor. In FIG. 1 as well as FIG. 2, the inductor and the armature winding are represented as centred, i.e. the inductor axis 30 and the armature winding axis 35 coincide.

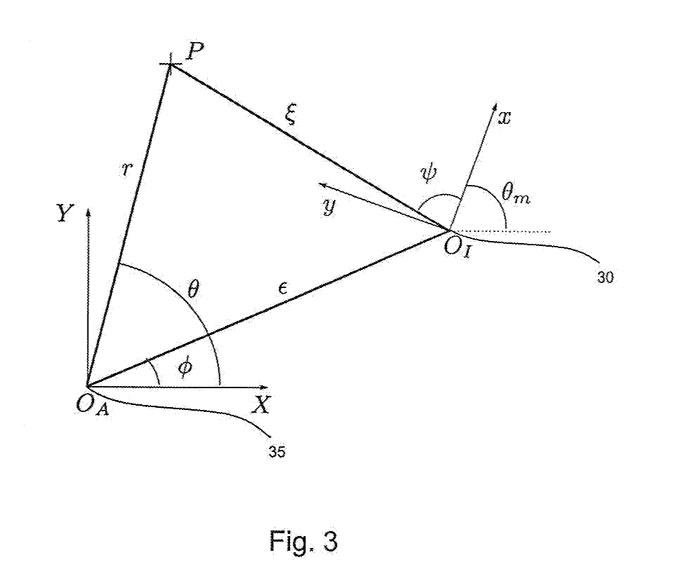

Throughout next sections various cylindrical coordinates and frames will be used, as illustrated in FIG. 3. One frame is attached to the inductor centre O_{I}. Another frame is attached to the armature winding centre O_{A}. The inductor axis 30 and the armature winding axis 35 are perpendicular to the drawing. The cylindrical coordinates of a point P in the frame attached to the armature winding are (r, θ) and in the frame attached to the inductor are (ξ, ψ). The cylindrical coordinates of the inductor centre O_{I} in the frame attached to the armature are (ε, φ). (ε, φ) represents the decentring of the inductor with respect to the armature winding. The frame attached to the inductor is rotated by an angle θₘ with respect to the frame attached to the winding.

For explaining the invention we will express the magnetic field created by an inductor producing a radial magnetic field having a number of pole pairs, p=1, 2, 3 . . . . This magnetic field will be first expressed in the frame attached to the inductor centre O_{I}.

Neglecting the end-effect in the axial direction, the magnetic vector potential produced by the inductor has only one component directed along the axial axis, and can be written as a Fourier series expansion:

$${A}_{M \hat{z}} = {\sum }_{n = 1}^{∞} ( \frac{{K}_{1 , n}}{{ξ}^{pn}} + {K}_{2 , n} {ξ}^{pn} ) sin ( pn ψ ) + ε ( {K}_{3 , n} {ξ}^{pn - 1} + \frac{{K}_{4 , n}}{{ξ}^{pn - 1}} ) sin ( ( pn - 1 ) ψ - {θ}_{m} + φ ) + ε ( {K}_{5 , n} {ξ}^{pn + 1} + \frac{{K}_{6 , n}}{{ξ}^{pn + 1}} ) sin ( ( pn + 1 ) ψ - {θ}_{m} + φ ) ,$$

where ξ and ψ are the coordinates of a point P in a frame attached to the inductor, as illustrated on FIG. 3, while ε and φ are respectively the amplitude and the direction of the decentring of the inductor relative to the winding. The constants K_{1,n} K_{2,n} K_{3,n} K_{4,n} K_{5,n} K_{6,n} depend on the geometric and magnetic properties of the inductor. The second and third terms of this expression, proportional to the amplitude ε of the decentring of the inductor, are only present when a ferromagnetic yoke is associated with the armature winding, and result from the flux-guiding effect of the ferromagnetic yoke on a decentred inductor. Constants K_{1,n} are more significant compared to K_{2,n} when the inductor is internal, whereas constants K_{2,n} are more significant compared to K_{1,n} when the inductor is external. The magnetic vector potential produced by a decentring of the inductor with respect to the armature winding in the frame attached to the winding is obtained with the change of variables:

$$\{ \begin{matrix}ψ = θ - {θ}_{m} + {\sum }_{q = 1}^{∞} \frac{1}{q} {( \frac{ε}{r} )}^{q} sin ( q ( θ - φ ) ) \\ ξ = \sqrt{{r}^{2} + {ε}^{2} - 2 r ε cos ( θ - φ )}\end{matrix}$$

where r and θ are the coordinates of point P in the global coordinate system.

The expression of the magnetic vector potential A_{Mz} can then be developed into a Taylor series as a function of the decentring amplitude ε in the vicinity of the centred position, i.e. ε=0, in order to highlight the most significant components of the magnetic vector potential produced by a decentring, those that could generate the highest induced currents in the armature windings and therefore the highest recentring forces. This development gives rise to three terms:

$${A}_{M \hat{z}} = {\sum }_{n = 1}^{∞} {C}_{1 , n} sin ( pn ( θ - {θ}_{m} ) ) + \frac{ε}{r} {\sum }_{n = 1}^{∞} {C}_{2 , n} sin ( ( pn + 1 ) θ - pn {θ}_{m} - φ ) + \frac{ε}{r} {\sum }_{n = 1}^{∞} {C}_{3 , n} sin ( ( pn - 1 ) θ - pn {θ}_{m} + φ )$$

$$where$$

$${C}_{1 , n} = \frac{{K}_{1 , n}}{{r}^{pn}} + {K}_{2 , n} {r}^{pn}$$

$${C}_{2 , n} = pn \frac{{K}_{1 , n}}{{r}^{pn}} + {K}_{5 , n} {r}^{pn + 2} + \frac{{K}_{6 , n}}{{r}^{pn}}$$

$${C}_{3 , n} = - {pnK}_{2 , n} {r}^{pn} + {K}_{3 , n} {r}^{pn} + \frac{{K}_{4 , n}}{{r}^{pn - 2}}$$

The first term corresponds to the magnetic vector potential seen by the winding when the inductor is centred. As will be explained hereafter, this term induces no current in a null-flux armature winding. Therefore, losses are avoided when the inductor is properly centred. The two last terms correspond to the magnetic field due to the decentring. These terms induce currents in the armature windings.

Focusing more specifically on the effects of the fundamental component of the magnetic field generated by the inductor, which is justified by the fact that it is generally dominant, the magnetic vector potential generated by a centre shift reduces to:

$${A}_{M \hat{z}} = {C}_{1} sin ( p ( θ - {θ}_{m} ) ) + \frac{ε}{r} {C}_{2} sin ( ( p + 1 ) θ - p {θ}_{m} - φ ) + \frac{ε}{r} {C}_{3} sin ( ( p - 1 ) θ - p {θ}_{m} + φ )$$

It is therefore interesting to note that the magnetic vector potential generated by the decentring has a spatial periodicity equal to 2π/(p+1) and 2π/(p−1). The magnetic flux density related to this magnetic vector potential is therefore characterized by a number of pole pairs equal to p+1 and p−1. To intercept as best this magnetic flux density with the armature windings, and thereby maximize the useful effect of the electrodynamics bearing, it therefore appears that the latter must have a number of pole pairs also equal to p+1 and/or p−1. With such a number of pole pairs, the armature windings will not intercept any magnetic flux related to the magnetic field produced by the inductor when centred, this being characterized by a number of pair of poles equal to p. This can be understood by considering that the magnetic flux intercepted by a winding composed of Nₛ turns is given by the general relationship:

Ψ=Nₛ∫_{S}\vec{B}\vec{dS}

where S is the surface defined by the winding. This relationship can be rewritten as a function of the magnetic vector potential as follows:

Ψ=Nₛ [symbol] \vec{A}\vec{dl}

where Γ is the closed path embracing the surface S.

In the present case, as the magnetic vector potential is purely axial, and in the case where the armature windings are of window-frame type, the magnetic flux intercepted by the armature windings takes the particular form:

$$Ψ = {N}_{s} l {\sum }_{i = 1}^{2 q} {( - 1 )}^{i} [ {C}_{1} sin ( p ( {θ}_{i} - {θ}_{m} ) ) + ( \frac{ε}{r} ) {C}_{2} sin ( ( p + 1 ) {θ}_{i} - p {θ}_{m} - φ ) + ( \begin{matrix}ε \\ r\end{matrix} ) {C}_{3} sin ( \begin{matrix}( \begin{matrix}p & 1\end{matrix} ) {θ}_{i} & p {θ}_{m} & \vert & φ\end{matrix} ) ]$$

where l is the winding axial length and θᵢ, given by:

θᵢ=θ₀+(i−1)π/q

corresponds to the position of the forth conductors for i=1, 3, . . . 2q−1 and of the back conductors for i=2, 4, . . . , 2q. The armature winding has q pole pairs. The expression of the magnetic flux can then be rewritten:

$$Ψ = {N}_{s} l {\sum }_{i = 1}^{2 q} [ {C}_{1} sin ( i π ( p + q ) / q - p {θ}_{m} + p {θ}_{0} - π p / q ) + ( \frac{ε}{r} ) {C}_{2} sin ( i π ( p + 1 + q ) / q - p {θ}_{m} - φ + ( p + 1 ) {θ}_{0} - π ( p + 1 ) / q ) + ( \frac{ε}{r} ) {C}_{3} sin ( i π ( p - 1 + q ) / q - p {θ}_{m} + φ + ( p - 1 ) {θ}_{0} - π ( p - 1 ) / q ) ]$$

If q, the number of pole pairs of the armature windings, is equal to p+1 this expression reduces to:

$$Ψ = {N}_{s} l {\sum }_{i = 1}^{2 q} [ {C}_{1} sin ( - i π / q - p {θ}_{m} + p {θ}_{0} - π p / q ) + ( \frac{ε}{r} ) {C}_{2} sin ( - p {θ}_{m} - φ + ( p + 1 ) {θ}_{0} - π ( p + 1 ) / q ) + ( \frac{ε}{r} ) {C}_{3} sin ( - i 2 π / q - p {θ}_{m} + φ + ( p - 1 ) {θ}_{0} - π ( p - 1 ) / q ) ]$$

In this equation, the first term of the sum corresponds to the components of the magnetic flux related to the magnetic field produced by the inductor when centred, while the second and third terms correspond to the components of the magnetic flux related to the additional magnetic field produced by the inductor when centre shifted. As expected, the components of the first term cancel each other because to each component i=1, . . . , q corresponds a component i+q equal in magnitude but opposite in sign. The components of the second term being all identical, both in amplitude and sign, they simply add to produce a magnetic flux directly linked to the decentring ε.
The components of the third term result in the double of the summation from i=1 to i=q because to each component i=1, . . . , q corresponds a component i+q equal in magnitude and of same sign. This summation from i=1 to i=q corresponds to the summation of sinus of the same amplitude but with a phase shift relatively to each other of 2*π/q, which means that the sum cancels In conclusion, an armature winding with p+1 pole pairs will optimally intercept the magnetic flux component in p+1 related to the magnetic field produced by the inductor when centre shifted while keeping the characteristics of a null-flux coil. As in the case of an internal inductor, C₂>>C₃ because K₁>>K₂, the second term in periodicity (p+1) is more important than the third term in periodicity (p−1). Even if the conductors are not evenly distributed and are not purely axial like in window frame windings, but when respecting a periodicity such that for each conductor θᵢ corresponds a conductor θ_{q+i} situated at an angular distance π from the first conductor, when p is odd, and π+π/p, when p is even, above reasoning remains true concerning the cancelling of the first term. However, in this case the armature winding will intercept only a fraction of the second term but also a part of the third term.

Similarly, if q, the number of pole pairs of the armature windings, is equal to p−1 the expression for the flux reduces to:

$$Ψ = {N}_{s} l {\sum }_{i = 1}^{2 q} [ {C}_{1} sin ( i π / q - p {θ}_{m} + p {θ}_{0} - π p / q ) + ( \frac{ε}{r} ) {C}_{2} sin ( i 2 π / q - p {θ}_{m} - φ + ( p + 1 ) {θ}_{0} - π ( p + 1 ) / q ) + ( \frac{ε}{r} ) {C}_{3} sin ( - p {θ}_{m} + φ + ( p - 1 ) {θ}_{0} - π ( p - 1 ) / q ) ]$$

In this equation, the first term of the sum corresponds to the components of the magnetic flux related to the magnetic field produced by the inductor when centred, while the second and third terms correspond to the components of the magnetic flux related to the additional magnetic field produced by the inductor when decentred. Again, the components of the first term cancel each other because to each component i=1, . . . , q corresponds a component i+q equal in magnitude but opposite in sign. Generally, the components of the second term result in the double of the summation from i=1 to i=q because to each component i=1, . . . , q corresponds a component i+q equal in magnitude and of same sign. This summation from i=1 to i=q corresponds to the summation of sinus of the same amplitude but with a phase shift relatively to each other of 2*π/q, which means that the sum cancels. In the particular case where p=2 and q=1, the components of the second term do not cancel, and will produce a magnetic flux contributing to the centring force. The components of the third term being all identical, both in amplitude and sign, they simply add to produce a magnetic flux directly linked to the decentring ε. In conclusion, an armature windings with p−1 pole pairs will optimally intercept the magnetic flux component in p−1 related to the magnetic field produced by the inductor when centre shifted while keeping the characteristics of a null-flux coil. In the case of an external inductor C₃>>C₂ because K₂>>K₁ and the third term in periodicity (p−1) is more important than the second term in periodicity (p+1).
Even if the conductors are not evenly distributed and are not purely axial like in window frame windings, but when respecting a periodicity such that for each conductor θᵢ corresponds a conductor θ_{q+i} situated at an angular distance π from the first conductor, when p is odd, and π+π/p, when p is even, above reasoning remains true concerning the cancelling of the first term. However, in this case the armature winding will intercept only a fraction of the third term but also a part of the second term.

The above discussion applies to an inductor having p pole pairs in a radial direction, p being equal to or larger than 1. We now consider the case of an inductor producing a radial magnetic field characterized by a number of pairs of poles p=0 and an armature winding comprising a window-frame winding with or without ferromagnetic yoke. A p=0 inductor may be obtained by arranging a plurality of permanent magnets around an axis, each having a radial magnetization. In this case, neglecting the end-effect in the axial direction, the magnetic vector potential produced by the inductor takes the form:

A_{M\hat{z}}=A_{M0}ψ

Using the same approach as in the previous cases, it results that the additional component of the magnetic field produced by a decentring is characterized by a number of pole pairs equal to 1. To intercept as best this magnetic flux density with the armature windings, and thereby maximize the useful effect of the electrodynamic bearing, it therefore appears that the latter must have a number of pole pairs also equal to 1. All these results were obtained for window-frame windings, but they remain valid for any type/shape of armature windings, provided they are characterized by a number of pair of poles equal to p+1 and/or p−1.

The above equations and discussion applies to an inductor having p pole pairs in a radial direction. However, corresponding results can be obtained when the magnetic field of the inductor is directed axially, as discussed in relation to FIG. 2. The conclusions drawn above in relation to radial inductors therefore apply equally to axial inductors, i.e. the improved stiffness of a bearing where the armature winding has p+1 or p−1 poles.

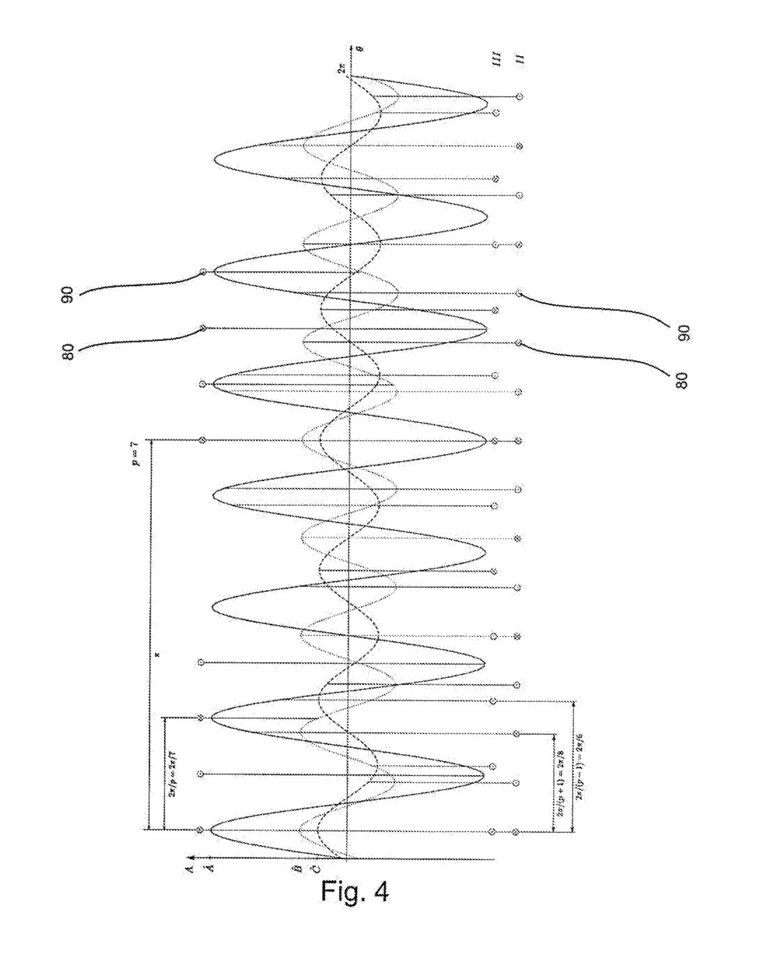

FIG. 4 represents components of the magnetic vector potential created by a seven pole pairs decentred inductor generating a radial field, expressed in a frame attached to the winding. The angle θ is the azimuthal angle about the armature winding centre. The main components of the vector potential are represented and comprise:
A first component A, represented as a solid line, having a number of pole pairs ‘p’ corresponding to the number of pole pairs of the inductor, and having a magnitude Â. This magnitude is independent of the magnitude ε of the decentring;
A second component B, represented as a dotted line, having a number of pole pairs ‘p+1’, and having a magnitude \hat{B}. This magnitude is proportional to the magnitude ε of the decentring;
A third component C, represented as a dashed line, having a number of pole pairs ‘p−1’, and having a magnitude Ĉ. This magnitude is proportional also to the magnitude ε of the decentring.
   The other components of the vector potential generated by the inductor at the winding, depending or not on the magnitude ε of the decentring, are of a smaller order of magnitude, and therefore of lesser importance for centring the electromagnetic bearing. The relative magnitudes of the components \hat{B} and Ĉ depend on the type of configuration of the bearing. For an internal inductor, components \hat{B} is larger than component Ĉ. For an external inductor, component Ĉ is larger than component \hat{B}. Each of these components of the vector potential, and their properties have corresponding components and properties for the magnetic field.

FIG. 4 also represents schematically three types of windings. The windings are “window frame windings” having rectilinear conductors parallel to the winding axis. Conductors represented by a circled x-mark (forth conductor 80) are connected to neighbouring conductors marked by a circled dot (back conductors 90), so as to form a loop, in a manner such that currents flow in opposite directions in two such conductors. The three winding types are:
A first winding I, known from the prior art, shown in the upper part of the figure, comprises two coils, each formed of two loops, connected in series, each having a period identical to the period of the inductor, 2π/p, or where the azimuthal distance between two successive conductors is equal to π/p. The two coils have an azimuthal extent smaller than π and are located at diametrically opposed locations.
A second winding II, shown in the bottom part of the figure, comprises eight loops connected in series each having a period equal to 2π/(p+1), or where the azimuthal distance between two successive conductors is equal to π/(p+1). This second winding has (p+1) pole pairs, and has an azimuthal extent of 2π.
A third winding III, shown immediately above winding II, comprises six loops connected in series each having a period equal to 2π/(p−1), or where the azimuthal distance between two successive conductors is equal to π/(p−1). This third winding has (p−1) pole pairs, and has an azimuthal extent of 2π.

Knowing that the share of a conductor (forth and back) to the flux through a loop is linked to the value of the vector potential at this conductor, a value proportional to the maximum magnitude of the flux through each of the windings I, II, and III is given in the following table:

| Winding | I | II | III |
|---|---|---|---|
| Vector potential | winding with ‘p1’ pole | winding with ‘p+1’ pole | winding with ‘p−1’ pole |
| component | pairs | pairs | pairs |
| A | 0 | 0 | 0 |
| ‘p’ pole pairs, | | | |
| magnitude Â | | | |
| independent of ε | | | |
| B | 2*2 loops : 3.8991 \hat{B} | 2*8 loops : 16 \hat{B} | 0 |
| ‘p+1’ pole pairs, | 2*4 loops : 7.0268 \hat{B} | | |
| magnitude \hat{B} | 2*6 loops : 8.7626 \hat{B} | | |
| proportional to ε, | | | |
| predominating when | | | |
| the inductor is internal | | | |
| C | 2*2 loops : 3.8991 Ĉ | 0 | 2*6 loops : 12 Ĉ |
| ‘p-1’ pole pairs, | 2*4 loops : 7.0268 Ĉ | | |
| magnitude Ĉ | 2*6 loops : 8.7626 Ĉ | | |
| proportional to ε, | | | |
| predominating when | | | |
| the inductor is external | | | |

The following conclusions can be drawn from this table:
The three windings filter component A of the vector potential. All three windings are “null-flux” windings. Component A being the only component present when ε is zero, no current is generated in the windings I, II and III when inductor axis and winding axis are coincident.
No energy is lost in this case.
Winding II completely filters component C of the vector potential. The flux associated with component B and going through winding II is larger than the flux of component B going through winding I. Therefore, winding II has a larger emf, and therefore a larger recentring force than winding I when component B is predominating i.e. when the inductor is an internal inductor.
Winding III completely filters component B of the vector potential. The flux associated with component C and going through winding III is larger than the flux of component C going through winding I. Therefore, winding III has a larger emf, and therefore a larger recentring force than winding I when component C is predominating i.e. when the inductor is an external inductor.
   Although windings II and III are represented as having p+1 and p−1 pole pairs respectively, with 2(p+1) or 2(p−1) conductors distributed uniformly around the armature axis, it will be understood that the centring forces will be active in the case where not all conductors 2(p+1) or 2(p−1) conductors are present, provided at least one pair of loops at an azimuthal angular distance 2π/(p+1) or 2π/(p−1) are connected in a closed circuit in such a manner that induced currents flow in the directions indicated by circled crosses and dots.

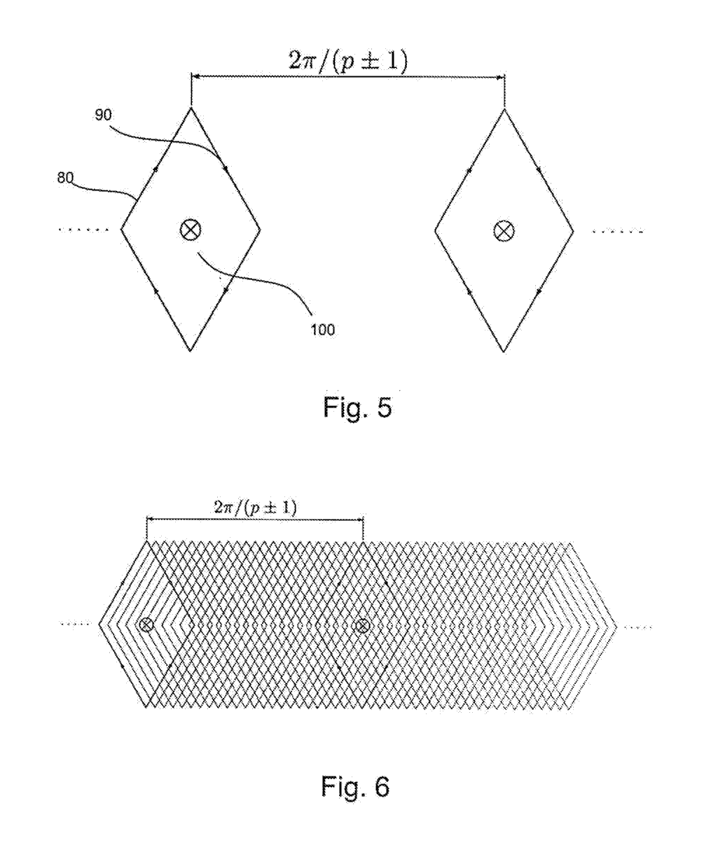

As represented on FIG. 5, a winding for a bearing according to an embodiment of the invention may be of the kind known in the art as a lap winding. A forth conductor 80 is connected at the top of the figure to a back conductor 90 so as to form a loop 100. The circled cross in loop 100 represents the direction of the magnetic field created when a current flows in the conductors as indicated by the arrows. This magnetic field forms a pole of the winding. The magnetic field direction is pointing into the figure. The back conductor of the left-hand loop is connected to the forth conductor of the right-hand loop through an azimuthal connection not represented on the drawing. Successive loops are connected so as to form a closed circuit forming a full 2π circle of the winding and having either p+1 or p−1 poles and corresponding poles in the opposite direction in between.

FIG. 6 shows how a plurality of the windings of FIG. 4 is repeated between two successive poles, so as to form a winding having an increased recentring force. In addition, the recentring force is more evenly distributed around the axis.

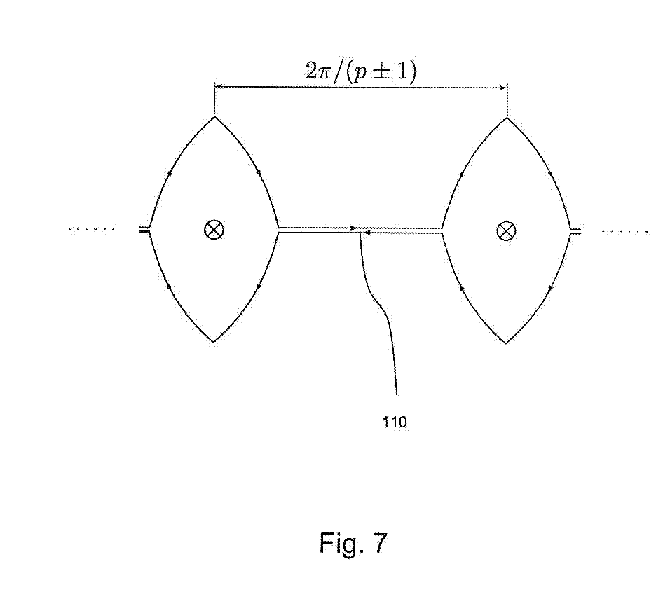

FIG. 7 shows an improved winding where conductors, instead of being rectilinear as the conductors of FIG. 4, are curved, with a curvature. The curvature may be determined so as to optimize the ratio ωL/R, where ω is the rotation speed of the bearing, L is the inductance of the winding, and R its resistance. The curvature may also be optimized in order to increase the ratio of the flux due to the inductor intercepted by the winding, to its impedance. FIG. 7 illustrates an alternative interloop-connection, where the azimuthal connections are located at the median plane of the winding.

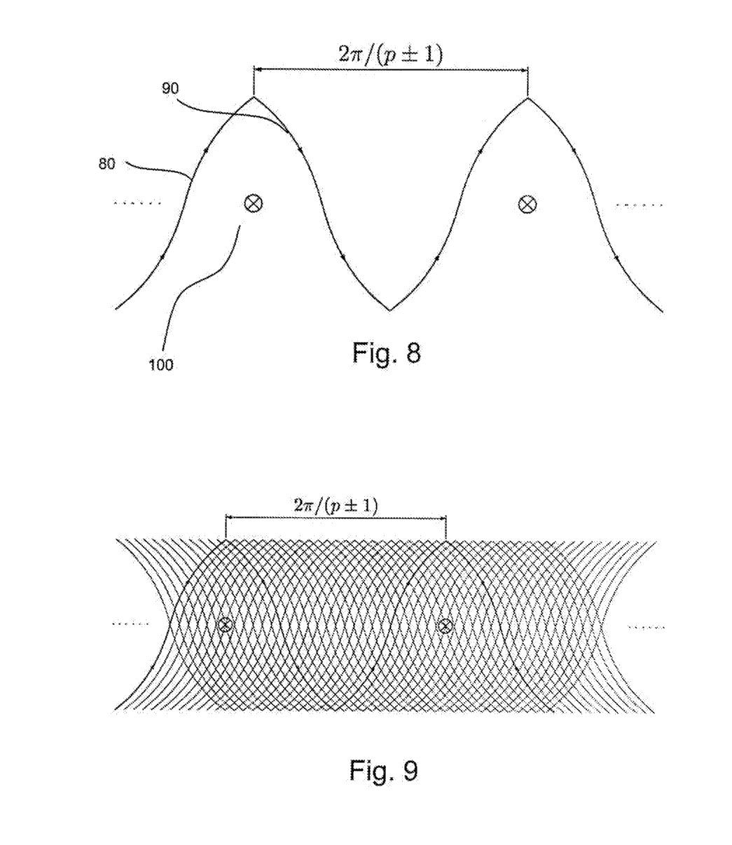

As represented on FIG. 8, a winding for a bearing according to another embodiment of the invention may be of the kind known in the art as a wave winding. A forth conductor 80 is connected at the top of the figure to a back conductor 90 so as to form a loop 100. The circled cross in loop 100 represents the direction of the magnetic field created when a current flows in the conductors as indicated by the arrows. This magnetic field forms a pole of the winding. The magnetic field direction is pointing into the figure. The back conductor of the left-hand loop is immediately connected to the forth current of the right-hand loop. Successive loops are connected as indicated so as to form a closed circuit forming a full 2π circle of the winding and having either p+1 or p−1 poles and corresponding poles in the opposite direction in between.

FIG. 9 shows how a plurality of the windings of FIG. 8 is repeated between two successive poles, so as to form a winding having an increased recentring force.

These windings may be constructed with wire, or alternatively, as flexible PCBs.

Advantages brought by the radial bearing of the invention are an increased stiffness.

The present invention has been described in terms of specific embodiments, which are illustrative of the invention and not to be construed as limiting. More generally, it will be appreciated by persons skilled in the art that the present invention is not limited by what has been particularly shown and/or described hereinabove.

Reference numerals in the claims do not limit their protective scope. Use of the verbs “to comprise”, “to include”, “to be composed of”, or any other variant, as well as their respective conjugations, does not exclude the presence of elements other than those stated. Use of the article “a”, “an” or “the” preceding an element does not exclude the presence of a plurality of such elements.

The invention may also be described as follows: the invention provides a radial bearing for supporting a shaft of a rotating device comprising a) an inductor having an inductor axis, generating a magnetic field having p pole pairs; b) an armature winding having loops disposed around an armature axis, magnetically coupled to said magnetic field, and connected in a closed circuit in such a manner that the net flux variation intercepted by said armature winding when said inductor and said armature winding are in rotation with respect to each other is zero when said inductor axis and said armature axis coincide and c) a gap between said inductor and said armature winding. The armature winding comprises p−1 or p+1 pole pairs when p is larger than or equal to 1 and comprises one pole pair when p is equal to 0.

1-11. (canceled)

12. A radial bearing for supporting a shaft of a rotating device comprising
a) an inductor having an inductor axis, generating a magnetic field having p pole pairs;
b) an armature winding having loops disposed around an armature axis, magnetically coupled to said magnetic field, and connected in a closed circuit in such a manner that the net flux variation intercepted by said armature winding when said inductor and said armature winding are in rotation with respect to each other is zero when said inductor axis and said armature axis coincide and
c) a gap between said inductor and said armature winding;
wherein said armature winding comprises p−1 or p+1 pole pairs when p is larger than or equal to 1 and said armature winding comprises one pole pair when p is equal to 0.

13. The radial bearing according to claim 12, wherein said armature winding comprises p+1 or p−1 loops distributed uniformly around the armature axis.

14. The radial bearing according to claim 12, wherein said magnetic field is radial to said inductor axis.

15. The radial bearing according to claim 14, wherein said inductor is internal to said armature winding and said armature winding comprises p+1 pole pairs.

16. The radial bearing according to claim 14, wherein said inductor is external to said armature winding and said armature winding comprises p−1 pole pairs.

17. The radial bearing according to claim 12, wherein said magnetic field is axial in relation to said inductor axis.

18. The radial bearing according to claim 12, wherein said inductor is a rotor adapted for rotating around an axis.

19. The radial bearing according to claim 12, wherein said armature winding is a rotor adapted for rotating around an axis.

20. The radial bearing according to claim 12, wherein said armature winding is a lap winding.

21. The radial bearing according to claim 12, wherein said armature winding is a wave winding.

22. The radial bearing according to claim 12, wherein said inductor comprises a Halbach array.
